(19) United States
(12) Patent Application Publication
(10) Pub. No.: US 2003/0117669 A1
(43) Pub. Date: Jun. 26, 2003

(54) Method and apparatus for fast image fetching and processing

(76) Inventors: Jewel Tsai, Hsinchu (TW); Hsi-Hsun Huang, Tauyuang (TW); Nora Wen, Hsinchu (TW)

Correspondence Address: LOWE HAUPTMAN GILMAN & BERNER, LLP, Suite 310, 1700 Diagonal Road, Alexandria, VA, 22314, US

(21) Appl. No.: 10/024,492

(22) Filed: Dec. 21, 2001

(51) Int. Cl. H04N 1/00; H04N 1/04

(52) U.S. Cl. 358/474; 358/402

(57) ABSTRACT

A method and apparatus for fast image fetching and processing is provided to scan an object more efficiently by a one-touch operation. The method and apparatus allows a one-touch operation to initiate a series of actions previously defined in a configuration file for each function key, including scan, print, facsimile, e-mail or OCR, thereby provide a more user friendly interface for operating the office machine.

### BACKGROUND OF THE INVENTION

A. Field of the Invention

The present invention relates to a method and apparatus for fast image fetching and processing, especially to a method and apparatus which is capable of capturing and processing scanned images of a document or an object.

B. Description of the Prior Art

In today's highly computerized office environment, convenience and easy-to-learn characteristics are two important factors when purchasing an office machine. Accordingly, whether an office machine has a user-friendly interface becomes a major concern for the consumers while selecting an office machine. Among those office machines, the operations of optical image scanners can be roughly classified into the following categories:

1. Application program enabling type: The host computer will show all the available drivers on the display for an end-user to select. The user must manually select the associated scanner driver and then press the scan function key to start the pre-scan procedure. After that, the end-user also needs to further select an area of interest (AOI) from the pre-scanned image so that the image information of the AOI can be read and sent to an associated application program for processing. Such image reading and processing operation sequence is very inconvenient to the end-users, especially when they have done it repeatedly.

2. Function key enabling type: The user may press one of the function keys on the scanner to enable an associated application program. Then, all the available derivers will be displayed as a floating menu on the screen for the user to select. Then, the user can select the scan function from the floating menu to start the pre-scan procedure. After that, the user also needs to select an area of interest (AOI) from the pre-scan image to read the image data of the AOI and then send the image data to the application program for processing. However, this approach has only the advantage of partial automation at the very beginning when the user presses the function key on the scanner. The subsequent scanning operation procedure is basically the same. So, it is still not convenient enough in use.

In general, given these operations described above, the interfaces currently available for operating the scanners are still not convenient enough, especially for those who are not familiar with such office machines.

### SUMMARY OF THE INVENTION

Accordingly, it is an object of the present invention to provide a method and apparatus for fast image fetching and processing which provides a one-touch operation for an user to automatically initiate a series of actions previously defined, thereby to finish the associated jobs of scanning, printing, sending fax, or e-mails.

In a computer network including at least a host computer, a modulation/demodulation device (MODEM), a printer, and an optical scanner, the user only needs a one-touch operation to use these devices for scanning, printing, fax, e-mail or OCR. The user can press the scan function key on the scanner to read the image information of a document placed on the scanner. When the user presses the print function key on the scanner, the printer will print the image information of the document placed on the scanner. When the user presses the fax function key on the scanner and then keys in the fax number of the receiver, the image information of the document placed on the scanner will be sent to the associated receiver. When the user presses the e-mail function key on the scanner and then keys in the e-mail address of the receiver, the image information of the document placed on the scanner will be sent to the receiver as an attachment. When the user presses the Optical Character Recognition (OCR) function key on the scanner, the image information of the document placed on the scanner will be automatically analyzed by an associated OCR application program. To sum up, all these operations require only one-touch on the function key of the scanner, thereby make the operation of the scanner and associated office machines more conveniently and efficiently.

### BRIEF DESCRIPTION OF THE DRAWINGS

These and other objects and advantages of the present invention will become apparent by reference to the following description and accompanying drawings wherein:

FIG. 1 is a schematic diagram showing the computer network implemented with the inventive apparatus for fast image fetching and processing.

FIG. 2 is a schematic diagram showing an application program for image processing.

FIG. 3 is a schematic diagram showing an application program for e-mail transmission.

FIG. 4 is a flow chart showing the scan procedure according to the method of the invention.

FIG. 5 is a flow chart showing the print procedure according to the method of the invention.

FIG. 6 is a flow chart showing the fax procedure according to the method of the invention.

FIG. 7 is a flow chart showing the e-mail procedure according to the method of the invention.

FIG. 8 is a flow chart showing the OCR procedure according to the method of the invention.

### DETAILED DESCRIPTION OF THE PREFERRED EMBODIMENTS

A preferred embodiment of the invention is described below. This embodiment is merely exemplary. Those skilled in the art will appreciate that changes can be made to the disclosed embodiment without departing from the spirit and scope of the invention.

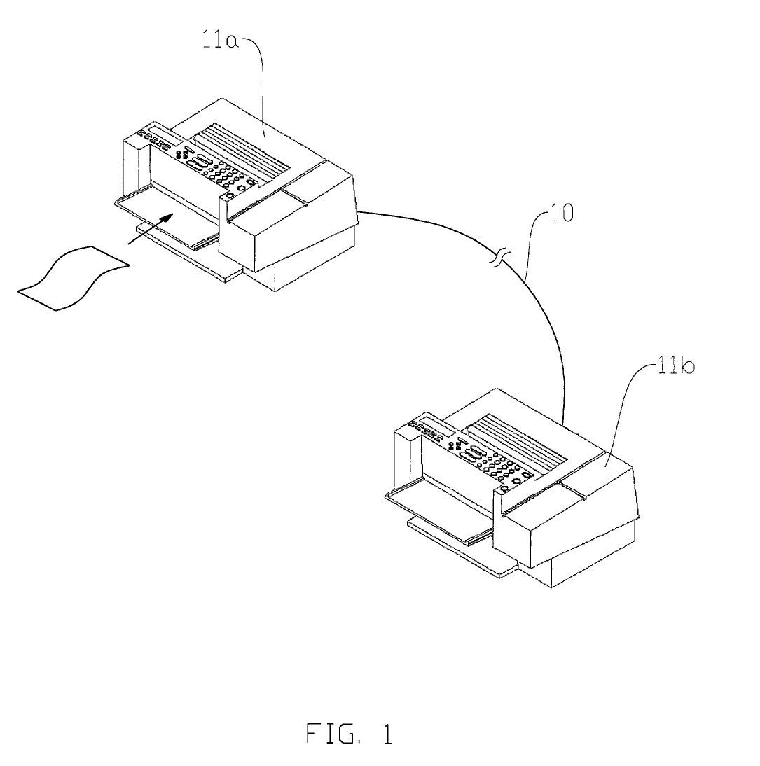

As illustrated in FIG. 1, a computer networks includes a host computer 10, and various output units, including: a MODEM 20, a printer 30, a scanner 40 and a display 50. The host computer 10 has a buffer 11, a driver 12, a control key configuration file 13, and various application programs 14 associated with the commands in the control key configuration file 13. The control key configuration file 13 can be repeatedly used after initial configuration. The scanner 40 is communicated with the host computer 10. On the housing of the scanner 40, there are multiple control keys 41˜45, each controlled by an associated command defined in the control key configuration file 13. When pressing any control key 41˜45, the associated driver 12 defined in the commands of the control key configuration file 13 will be enabled. Then, the scanner 40 will be driven by the driver 12 to read the image information of the object placed on the scanner 40 and convert it into digital image data. The digital image data will then be saved in the buffer 11. The digital image file will then be loaded into an associated application program 14 defined in the control key configuration file 13. The execution result of the application program 14 will be displayed in the output unit connected to the host computer 10. Accordingly, the user only needs one-touch key operation to operate the job of image fetching and processing according to the commands defined in the control key configuration file 13.

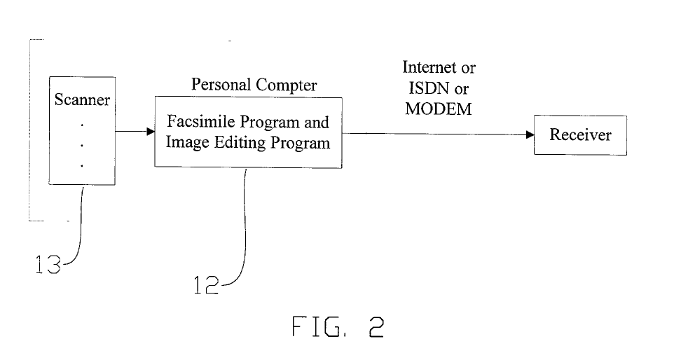

For example, when the scan function key 41 of the scanner 40 is pressed, an associated driver defined in the commands of the control key configuration file 13 will be enabled, thereby to read the image information of the object placed on the scanner 40. The scanned image of the object will then be converted into digital image data and saved in the buffer 11. The scanned image of the object will also be loaded into an associated application program defined in the commands of the control key configuration file 13, such as Photoshop. The image file will also be opened by an application program 14 and shown on a displayed 50 of the communicated host computer 10, as illustrated in FIG. 2. During the scanning procedure, the percentage of completion will also be displayed on the screen 50.

Moreover, when the print function key 42 of the scanner 40 is pressed, the driver 12 associated with the commands defined in the control key configuration file 13 will be enabled, such as MiniDriver, thereby drive the optical module of the scanner 40 to read the image information of the object placed on the scanner 40. The scanned image will then be saved as digital image data in the buffer 11. When print out the image of the object, the driver 12 will compare the resolution (Dot Per Inch, DPI) of the printer 30 with the scanned image to convert the scanned image to an output file in equal proportional. And then, the image file will be output from the printer 30 in the computer network. Also, during the scanning procedure, the display 50 will show the percentage of completion on the display 50.

When the fax function key 43 on the scanner 40 is pressed, the driver 12 associated with the commands defined in the control key configuration file 13 will be enabled, such as MiniDriver, thereby drive the optical module of the scanner 40 to read the image information of the object placed on the scanner 40. The image data is then saved in a buffer 11 and then loaded in an application program 14 associated with the command defined in the control key configuration file 13. The user may use the software keyboard on the display or use the digit buttons on the housing of the scanner 40 to key in the fax number of the receiver. After that, the image file previously loaded in the application program can be sent to the MODEM 20 in the computer network to send the scanned image to the receiver. The screen 50 will show the progress of the scanning job.

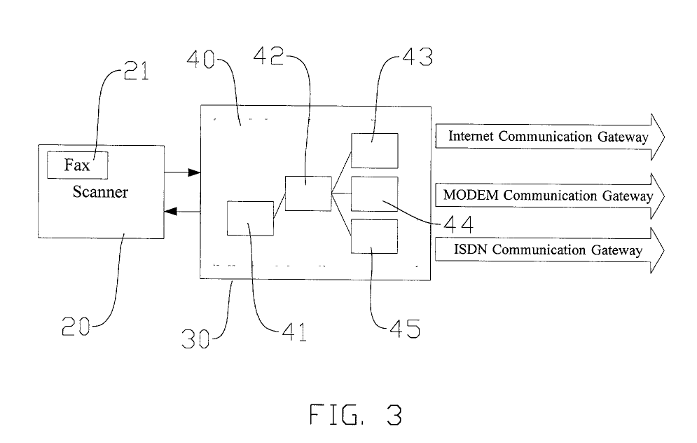

When the e-mail function key 44 on the scanner 40 is pressed, the driver 12 associated with the commands defined in the control key configuration file 13 will be enabled, such as MiniDriver, thereby drive the optical module of the scanner to read the image information of the object placed on the scanner 40. The image data is then saved in a buffer 11 and then loaded as an attachment in an application program 14 associated with the commands defined in the control key configuration file 13, such as Microsoft Outlook, as illustrated in FIG. 3. After the user types the e-mail address of the receiver, the image file will be sent as an attachment by the application program 14 and then sent to the receiver via the MODEM 20 in the computer network. Also, the screen 50 will show the progress of the scanning job.

When the Optical Character Recognition (OCR) function key 45 on the scanner 40 is pressed, the driver 12 associated with the commands defined in the control key configuration file 13 will be enabled, such as MiniDriver, thereby drive the optical module of the scanner 40 to read the image information of the object placed on the scanner 40 for OCR process. The image data is then saved in a buffer 11 and then loaded in an OCR application program 14 associated with the command defined in the control key configuration file 13. The image file will be opened by the OCR application program 14 for character recognition. The screen 50 will show the percentage of the completion for the scanning job.

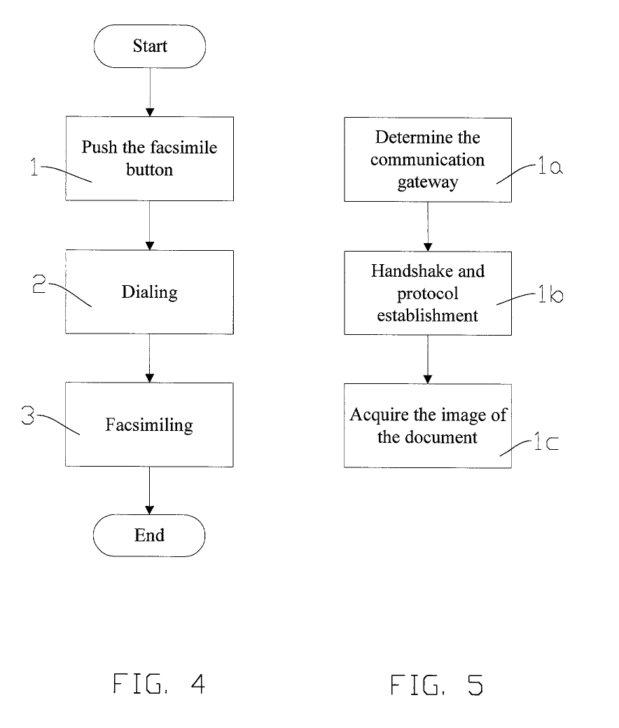

As illustrated in FIG. 4, the inventive method for image fetching and processing can be explained in more details as follows: When the user wishes to scan the image of an object, he presses the scan function key (101), the driver (Mini-Driver) will receive the message of the scan action (102). The driver will send the scan message to a watch routine (103). After that, the watch routine will send the scan message to Panel Control Module (104). The Panel Control Module Control Module loads ScanObj.dll and sends the scan command (105). The ScanObj.dll will send the message to the driver and request the driver to perform the scan action (106). During the scan procedure, the Panel Control Module Control Module will illustrate the graph showing the percentage of completion. When the scan job is finished, the driver transmits the scanned image to ScanObj.dll (107). ScanObj.dll then transmits the scanned image of the object to the Panel Control Module Control Module (108). The Panel Control Module Control Module then saves the scanned image of the object as a file (109), and then calls the application program to open the scanned image file of the object (110).

As illustrated in FIG. 5, the inventive method for image fetching and processing can be explained in more details as follows: When the user wishes to scan the image of the scanned object and then presses the copy function key (201), the Mini-Driver will receive the message of the print action (202). The driver then sends the message of the print action to the Watch routine (203). After that, the Watch routine forwards the message of the print action to Panel Control Module Control Module (204). Panel Control Module Control Module then loads ScanObj.dll and sends a scan command (205). ScanObj.dll sends a command to the driver and requests the driver to begin the scan action (206). At the same time, the Panel Control Module Control Module will show the percentage of the completion of the scan action. After the scan is finished, the driver sends the scanned image of the object to ScanObj.dll (207). ScanObj.dll then sends the scanned image of the object to Panel Control Module Control Module (208). After comparing the resolution of the printer with the scanned image, the Panel Control Module Control Module sends the scanned image of the object to a target printer in equal proportion (209). The printing action starts from the right top corner of the document and then outputs the scanned image of the object in equal proportion

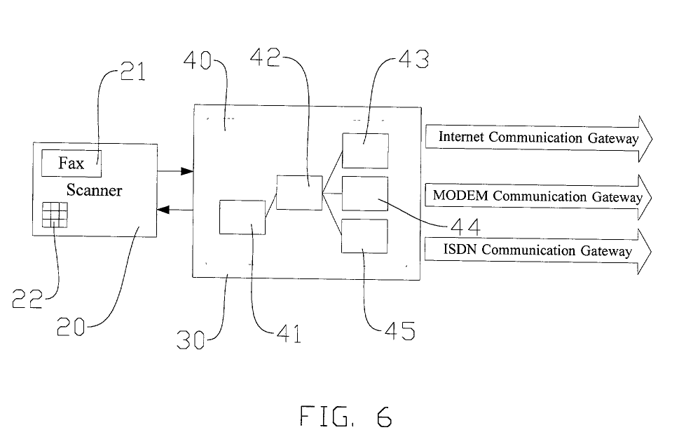

As illustrated in FIG. 6, the inventive method for image fetching and processing can be explained in more details as follows: When the user wishes to scan the image of the scanned object and then presses the fax function key (301), the Mini-Driver will receive the message of the fax action (302). The driver then sends the message of the fax action to the Watch routine (303). After that, the Watch routine sends the message of the fax action to Panel Control Module Control Module (304). Panel Control Module Control Module then loads ScanObj.dll and sends a scan command (305). ScanObj.dll sends a scan command to the driver and requests the driver to begin the scan action (306). During the scan procedure, the Panel Control Module Control Module will show the percentage of the completion of the scan action. After the scan is finished, the driver sends the scanned image of the object to ScanObj.dll (307). ScanObj.dll then sends the scanned image of the object to Panel Control Module Control Module (308). Panel Control Module Control Module then saves the scanned image of the object as a file (309). After the key-in the fax number of the receiver, the image file of the scanned object is sent to the receiver via fax (310).

As illustrated in FIG. 7, the inventive method for image fetching and processing can be explained in more details as follows: when the user wishes to send the image of the scanned object via e-mails and then presses the email function key (401), the Mini-Driver will receive the message of the e-mail action (402). The driver then sends the message of the e-mail action to the Watch routine (403). The Watch routine then sends the message of the e-mail action to Panel Control Module (404). Panel Control Module then loads ScanObj.dll and sends an e-mail transmission command (405). ScanObj.dll sends a command to the driver and requests the driver to begin the scan action (406). During the scan procedure, the Panel Control Module will show the progress of the scan action. After the scan action is finished, the driver sends the image of the scanned object to ScanObj.dll (407). ScanObj.dll then sends the scanned image to Panel Control Module (308). The Panel Control Module saves the scanned image as an image file (409). The Panel Control Module opens the e-mail application program to send a new email with the scanned image file as an attachment (410). After typing the e-mail address of the receiver, the e-mail will be sent.

As illustrated in FIG. 8, the inventive method for image fetching and processing can be explained in more details as follows: when the user wishes to scan the image of an object and then presses the OCR function key (501), the Mini-Driver will receive the message of the OCR action (502). The driver then sends the message of the OCR action to the Watch routine (503). The Watch routine then sends the message of the OCR action to Panel Control Module (504). Panel Control Module then loads ScanObj.dll and sends a scan command (505). ScanObj.dll sends a command to the driver and requests the driver to begin the scan action (506). At the same time, Panel Control Module will show the progress of the scan action. After the scan is finished, the driver sends the scanned image to ScanObj.dll (507). ScanObj.dll then sends the image of the scanned object to Panel Control Module (508). Panel Control Module saves the scanned image as an image file (509), and calls the associated OCR application program to perform image recognition and then save the result as a text file. After that, a text editor program, such as Microsoft Word, can be called to open the text file for edition (510).

In addition to operating the function keys on the scanner, the user can also perform the above mentioned actions by operating on the Panel Control Module from the screen. The Panel Control Module can be updated by downloading a new version from the Internet. The new Panel Control Module allows the user to perform any action associated with the above-mentioned jobs.

To sum up, the inventive method and apparatus provides an efficient user interface for image fetching and processing. The one-touch operation of the user interface allows the user to perform scan, print, fax, e-mails, or OCR action by just a single key operation, thereby to make the operations on the office machines more conveniently and efficiently.

It should be understood that various alternatives to the structures described herein may be employed in practicing the present invention. It is intended that the following claims define the invention and that the structure within the scope of these claims and their equivalents be covered thereby.

What is claimed is:

1. An apparatus for fast image fetching and processing comprising:
a host computer having a buffer, a driver, a control key configuration file, and an application program associated with said control key configuration file;
a scanner communicated with said host computer, said scanner having a plurality of function keys and an optical module, each of said plurality of function keys being operable in response to said control key configuration file, said optical module being controlled in response to said driver for reading an image of a scanned object and converting said scanned image to image data which is saved in said buffer and loaded in an application program associated with said control key configuration file; and
an output unit communicated with said host computer for generating the operation result of said application program.

2. The apparatus as claimed in claim 1, wherein said plurality of function keys comprises a scan function key, and said output unit is a display for viewing the scanned image of said scanned object opened by an image processor.

3. The apparatus as claimed in claim 1, wherein said plurality of function keys comprises a scan function key, and said output unit is a display for viewing the scanned image of said scanned object opened by an editor.

4. The apparatus as claimed in claim 1, wherein said plurality of function keys comprises a print function key, and said output unit is a printer for outputting the scanned image of said scanned object.

5. The apparatus as claimed in claim 1, wherein said plurality of function keys comprises a fax function key, and said output unit is a modulation/demodulation device (MODEM) which is enabled by an application program in response to said fax function key for transmitting the scanned image of said scanned object to a receiver after inputting a fax number of said receiver.

6. The apparatus as claimed in claim 5, wherein said application program further comprises a software keyboard for inputting said fax number.

7. The apparatus as claimed in claim 5, wherein said scanner further comprising:
digit buttons for inputting said fax number.

8. The apparatus as claimed in claim 1, wherein said plurality of function keys comprises an e-mail function key, and said output unit is a modulation/demodulation device (MODEM) which is enabled by an application program in response to said e-mail function key for transmitting the scanned image of said scanned object as an attachment file in a new e-mail.

9. The apparatus as claimed in claim 1, wherein said plurality of control keys comprises an Optical Character Recognition (OCR) function key for enabling an OCR application program to convert the scanned image of said scanned object to a text file and display the result on said output unit.

10. The apparatus as claimed in claim 9, wherein said output unit is a display for showing said Optical Character Recognition (OCR) application program and the process result of said scanned image.

11. A method for fast image fetching and processing, comprising the steps of:
providing a host computer having a buffer, a driver, a control key configuration file, and an application program associated with said control key configuration file;
providing a scanner communicated with said host computer, said scanner having a plurality of function keys and an optical module controlled by said driver, for converting a scanned image into digital image data;
defining said control key configuration file by recording the procedural steps for each of said plurality of function keys associated with an application program; and
performing said procedural steps in response to the operation of each of said plurality of function keys.

12. The method as claimed in claim 11, wherein said step of defining said control key configuration file comprises the step of:
defining a scan function key, an associated driver, an associated application program, an associated program routine to execute said driver and said application program for loading a scanned image.

13. The method as claimed in claim 12, wherein the execution of said control key configuration file comprises the steps of:
enabling said driver to read the scanned image of a scanned object in response to said scan function key;
saving said scanned image of said scanned object as an image file; and
calling said associated application program to open said image file.

14. The method as claimed in claim 11, wherein said step of defining said control key configuration file comprises the step of:
defining a print function key, an associated driver, an associated application program, an associated program routine to execute said driver and said application program for sending a scanned image to a printer.

15. The method as claimed in claim 14, wherein the execution of said control key configuration file comprises the steps of:
enabling said driver to read the scanned image of a scanned object in response to said print function key;
saving said scanned image of said scanned object as an image file; and
sending said image file to said printer.

16. The method as claimed in claim 11, wherein said step of defining a control key configuration file comprises the step of:
defining a fax function key, an associated driver, an associated application program, an associated program routine to execute said driver and said application program for sending a scanned image to a receiver via a MODEM.

17. The method as claimed in claim 16, wherein the execution of said control key configuration file comprises the steps of:
enabling said driver to read the scanned image of a scanned object in response to said fax function key;
saving said scanned image of said scanned object as an image file; and sending said image file to a receiver via said MODEM.

18. The method as claimed in claim 11, wherein said step of defining control key configuration file comprises the step of:
defining an e-mail function key, an associated driver, an associated application program, an associated program routine to execute said driver and said application program for loading a scanned image.

19. The method as claimed in claim 18, wherein the execution of said control key configuration file comprises the steps of:
enabling said driver to read the scanned image of a scanned object in response to said e-mail function key;
saving said scanned image of said scanned object as an image file; and
calling said associated application program to send said image file as an attachment file for a new e-mail transmission.

20. The method as claimed in claim 11, wherein said step of defining said control key configuration file comprises the step of:
defining an OCR function key, an associated driver, an associated application program, an associated program routine to execute said driver and said application program for loading a scanned image.

21. The method as claimed in claim 20, wherein the execution of said control key configuration file comprises the steps of:
enabling said driver to read the scanned image of a scanned object in response to said OCR function key;
saving said result of said OCR procedure as an image file; and
calling said associated application program to open said image file.
